(19) United States
(12) Patent Application Publication
(10) Pub. No.: US 2015/0108881 A1
(43) Pub. Date: Apr. 23, 2015

(54) Cabinet with Display Structure Showing Lock-Control State Thereof

(71) Applicant: Ting Yu Chang, Taichung City (TW)

(72) Inventor: Ting Yu Chang, Taichung City (TW)

(21) Appl. No.: 14/511,024

(22) Filed: Oct. 9, 2014

(30) Foreign Application Priority Data
Oct. 17, 2013 (TW) 102137489

(51) Int. Cl. B25H 3/02; A47B 81/00; G09F 3/00; E05B 65/46

(52) U.S. Cl. CPC B25H 3/028; E05B 65/462; A47B 81/00; G09F 3/00
USPC 312/219; 312/333

(57) ABSTRACT

A cabinet with display structure showing lock-control state thereof contains a cabinet body having a receiving space, a plurality of drawers slidably assembled in the receiving space, a lock-control unit and a display unit. The lock-control unit contains a driving member, a linking-up member and a lock-control member. The driving member drives the linking-up member to actuate, so that the linking-up member drives the lock-control member to control the drawers in unlocked or locked states. The display unit contains a slidable member and at least one display member. The slidable member moves laterally along with the actuation of the linking-up member and controls the at least one display member displaying the drawers in unlocked or locked states.

### CROSS-REFERENCE TO RELATED APPLICATION

This application claims priority to TW 102137489, filed on Oct. 17, 2013 with the Republic of China, Taiwan, the entire specification of which is hereby incorporated by reference.

### BACKGROUND OF THE INVENTION

1. Field of the Invention

The present invention relates to a cabinet for storing tools, and more particularly to a cabinet structure with display(s) showing the lock-control state thereof.

2. Description of the Prior Art

As shown in FIG. 9 and FIG. 10, a conventional cabinet with lock-control structure is illustrated and includes a cabinet body 91 having a receiving space 92, a plurality of drawers 93 slidably assembled in the receiving space 92, a lock-control unit including a lock 94, a rod member 95 and a seat 96. The lock 94 is driven by a key (not shown) so as to rotate the rod member 95 to drive the seat 96 to slide within a rail 97 fastened to the cabinet body 91, thereby controlling the drawers 93 in the cabinet body 91 in unlocked or locked states. However, several kinds of locks 94 are available in the market; some of them can be unlocked by 90 degrees rotation of the keys thereof, some of them can be unlocked by 180 degrees rotation of the keys thereof, while some of them even can only be unlocked by multiple rotations of the keys thereof Based on this, unless the user is very familiar to the cabinet, the user can hardly check whether the drawers 93 in the cabinet body 91 is unlocked or locked; thereby, the user would check if the drawers 93 are locked or unlocked by pulling the drawer 93 out, and once the user cannot pull out the drawers 93, a key of the lock 94 of the drawers 93 is then applied to unlock the lock 94 of the drawers 93, resulting in inconvenience for using the cabinet.

The present invention is, therefore, arisen to obviate or at least mitigate the above mentioned disadvantages.

### SUMMARY OF THE INVENTION

An object of the present invention is to provide a cabinet with display structure showing lock-control state thereof to solve the aforementioned problems, in which whether the drawers are unlocked or locked can be observed from the exterior of the cabinet body by naked eyes, so that the user can directly pull the drawers out of the cabinet body or unlock the drawer by a key, thus the user uses the cabinet according to the present invention conveniently.

To achieve the above and other objects, a cabinet with display structure showing lock-control state thereof comprises a cabinet body having a receiving space, a plurality of drawers slidably assembled in the receiving space, a lock-control unit and a display unit. The lock-control unit comprises a driving member, a linking-up member and a lock-control member. The driving member drives the linking-up member to actuate, so that the linking-up member drives the lock-control member to control the drawers in unlocked or locked states. The display unit comprises a slidable member and at least one display member. The slidable member moves laterally along with the actuation of the linking-up member and controls the at least one display member displaying the drawers in unlocked or locked states.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first embodiment of the present invention showing the drawers are assembled in the cabinet body;

FIG. 2 is a partial exploded view of the first embodiment of the present invention showing the relationship of the lock-control unit and the display unit in the cabinet body;

FIG. 3 is a partial enlarged view of FIG. 2;

FIG. 4 is a cross-sectional view of the first embodiment of the present invention showing the display unit is limited within the cabinet;

FIG. 5 is a schematic view of the first embodiment of the present invention showing the plate body is displayed as red right part in the window when locked;

FIG. 6 is a schematic view of the first embodiment of the present invention showing the plate body is displayed as green left part in the window when unlocked

FIG. 7 is a schematic view of a second embodiment of the present invention showing the display lamp is displayed as red light when locked;

FIG. 8 is a schematic view of the second embodiment of the present invention showing the display lamp is displayed as green light when unlocked;

FIG. 9 is a perspective view showing a conventional cabinet body assembled with plural drawers; and

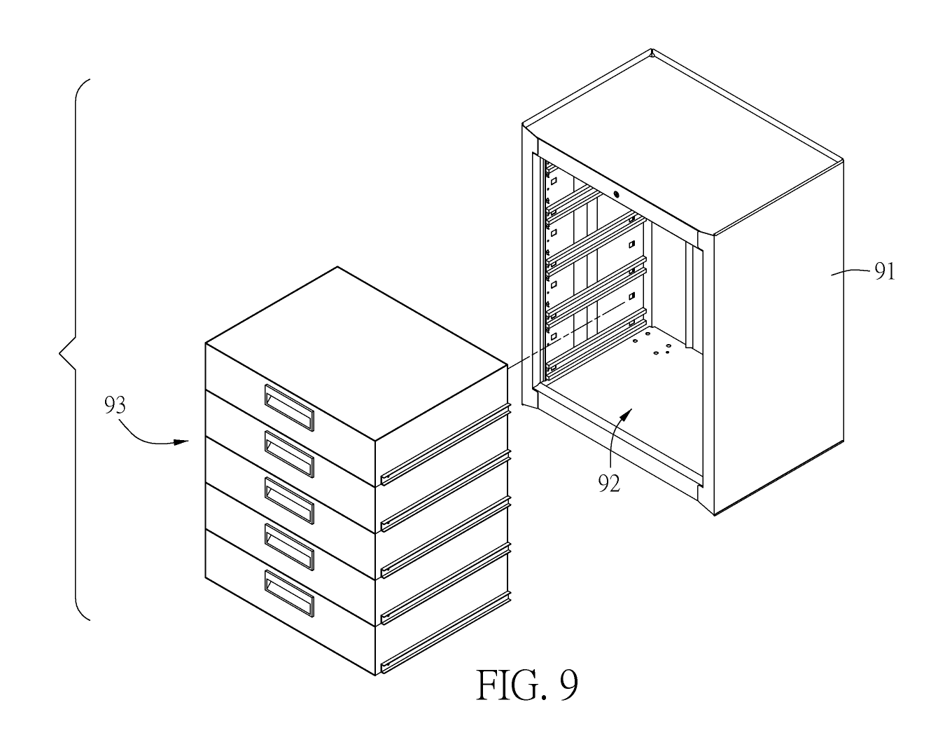

FIG. 10 is a cross-sectional view of a conventional cabinet with lock-control structure.

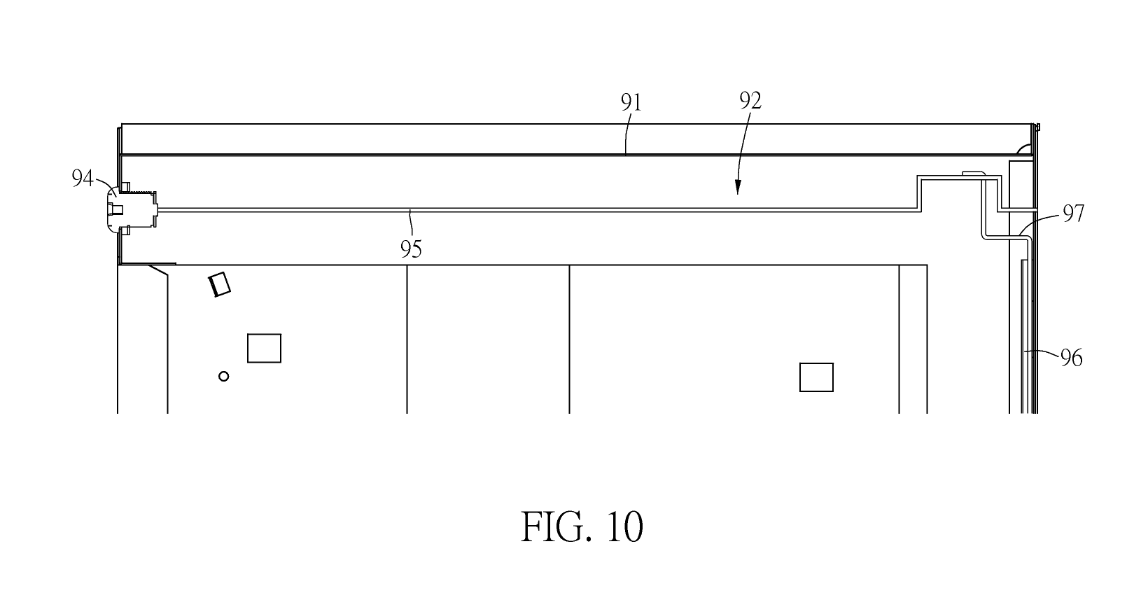

### DETAILED DESCRIPTION OF THE PREFERRED EMBODIMENTS

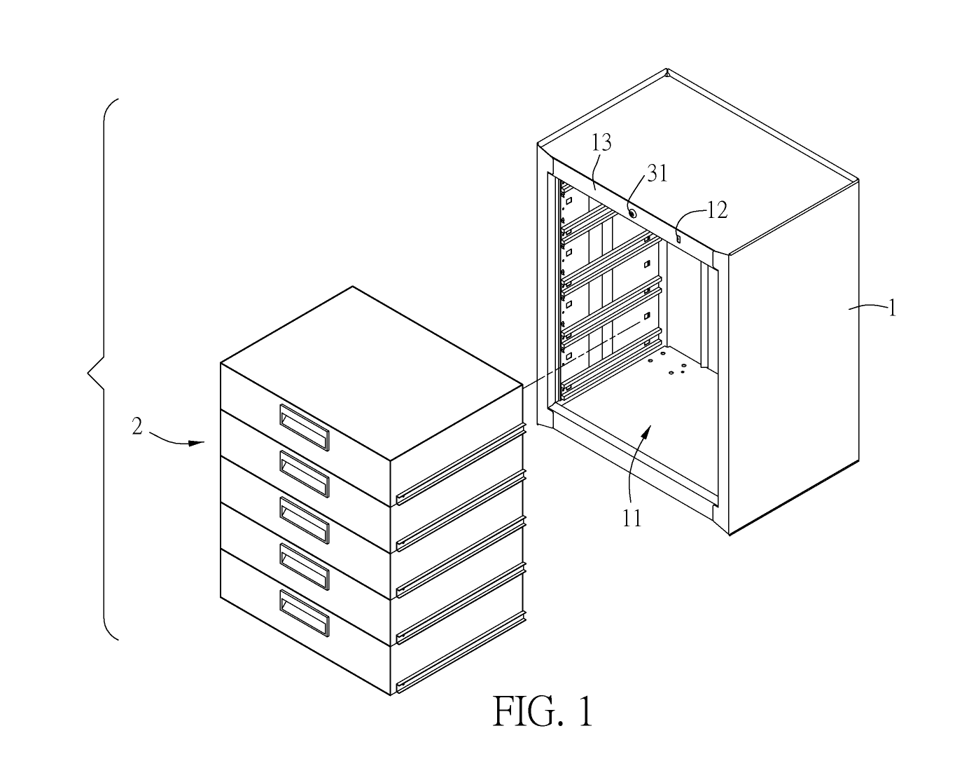

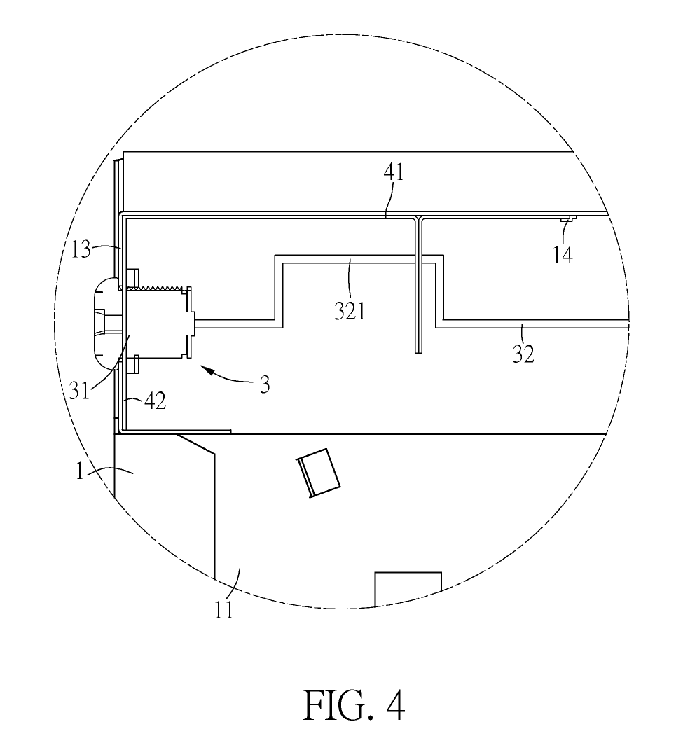

It is understood that, the structures shown in FIGS. 1-8 are exemplary embodiments of the present invention and are only provided for illustrative purposes, the scope of the present invention is not limited by the structures provided in the figures.

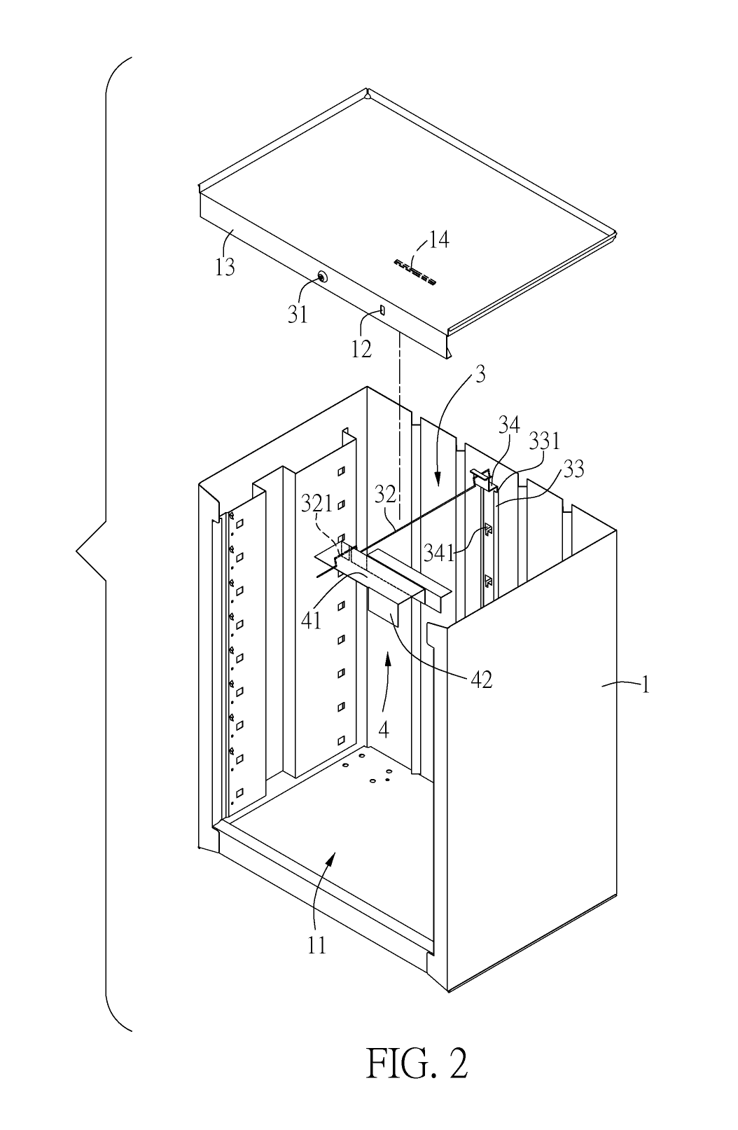

In this embodiment, as shown in FIG. 1 and FIG. 2, a cabinet with display structure showing lock-control states thereof is provided and includes a cabinet body 1, a plurality of drawers 2, a lock-control unit 3 and a display unit 4.

As shown in FIG. 1 and FIG. 2, the cabinet body 1 has a receiving space 11, and the drawers 2 are slidably assembled in the receiving space 11.

The lock-control unit 3 includes a driving member, a driving member, a linking-up member and a lock-control member. The driving member drives the linking-up member to actuate, so that the linking-up member drives the lock-control member to control the drawers 2 in unlocked states or in locked states.

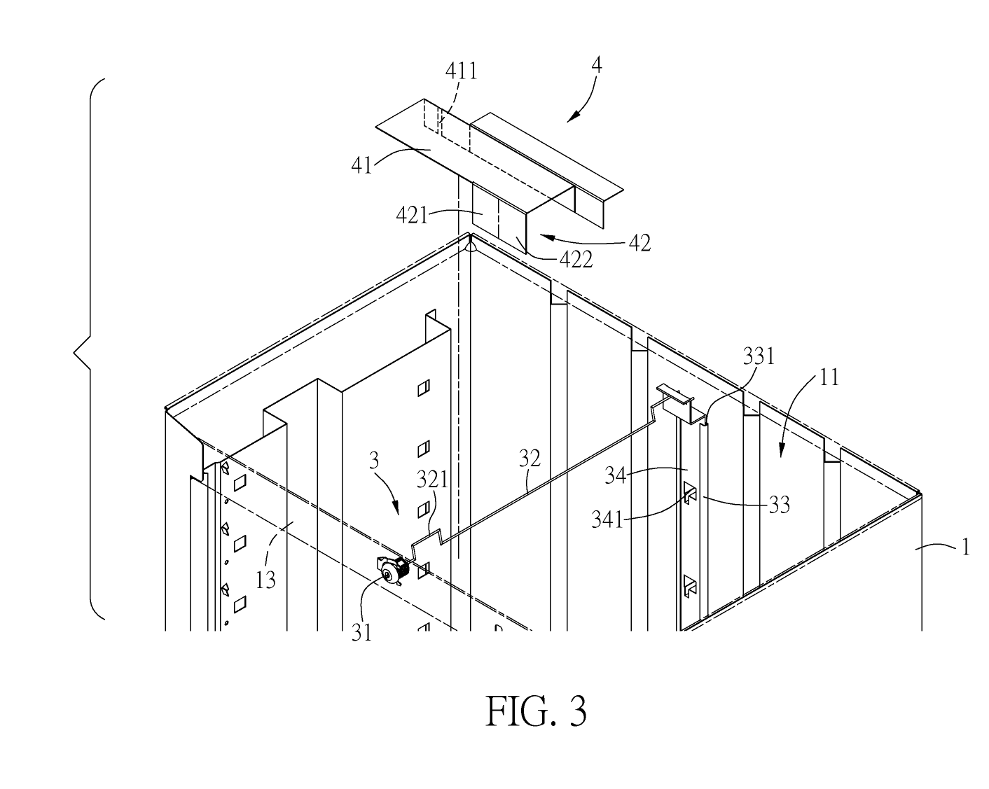

As shown in FIG. 2 and FIG. 3, the display unit 4 includes a slidable member 41 and a display member. The slidable member 41 moves laterally along with the actuation of the linking-up member and controls the display member displaying the drawers 2 in unlocked or locked state. In this embodiment, the display member is a plate body 42 connected to the slidable member 41; the plate body 42 is divided into a left part 421 and a right part 422, and different colors are labelled to the left part 421 and the right part 422. In this embodiment, the left part 421 is green colored, and the right part 422 is red colored.

Furthermore, in this embodiment, the driving member is a lock 31 capable of being unlocked by a key (not shown), and the linking-up member is a rod member 32 transversely passing through the cabinet body 1. The rod member 32 has a linking-up portion 321 corresponding to the slidable member 41, and the rod member 32 drives the slidable member 41 to slide using the linking-up portion 321. In this embodiment, the linking-up portion 321 is reversed U-profiled, and the slidable member 41 defines an accommodating groove 411 for correspondingly receiving the linking-up portion 321.

As shown in FIG. 2 and FIG. 3, the lock-control unit includes a guiding rail 33 and a seat 34. The guiding rail 33 is fixed on an inner wall of the cabinet body 1 and has a slidable groove 331, and the seat 34 has multiple engaging portions 341 slidably assembled in the slidable groove 331 of the guiding rail 33. One end of the rod member 32 is connected to the seat 34, thereby driving the seat 34 to slide to control the drawers 2 in unlocked or locked states.

Furthermore, the plate body 42 moves along with the movement of the slidable member 41, and the cabinet body 1 further includes a window 12 assembled within a sliding path of the slidable member 41, the window 12 is capable of aiming to the plate body 42. The plate body 42 displays the drawers 2 in unlocked or locked states in the window 12 along with the sliding movement of the slidable member 41. As shown in FIGS. 2-4, the window 12 is assembled to a front frame 13 of the cabinet body 1; the front side of the slidable member 41 is assembled in the front frame 13, while the rear side of the slidable member 41 is limited in a limiting member 14 fixed in the cabinet body 1, thereby the slidable member 41 is slidably movable in the cabinet body 1.

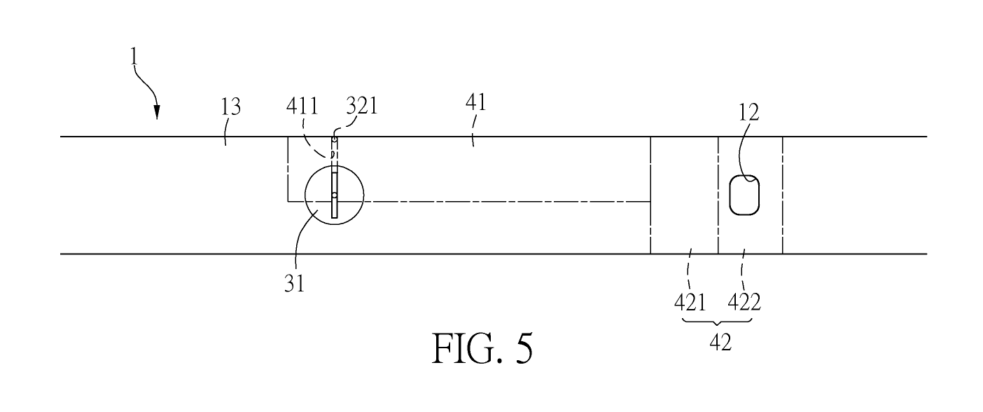

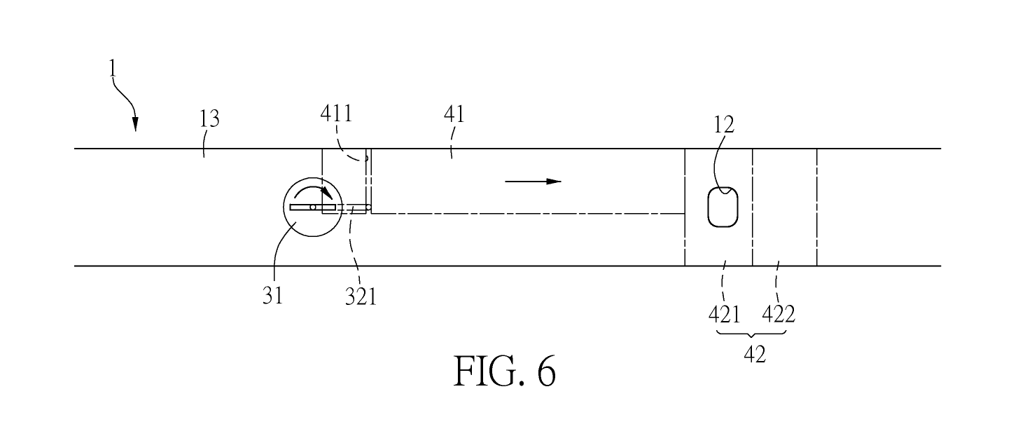

As shown in FIG. 5, the window 12 displays the right part 422 of the plate body 42 which is red colored; that means, the drawers 2 are locked and cannot be directly pulled out of the cabinet body 1; while as shown in FIG. 6, when the lock 31 is rotated by a key so as to drive the rod member 32 to rotate, so that the orientation of the linking-up portion 321 of the rod member 32 assembled in the accommodating groove 411 is altered, from a longitudinal direction to a lateral direction, thereby allowing the slidable member 41 to slide rightward; meanwhile, the portion of the plate body 42 displayed in the window 12 is changed, from the red-colored right part 422 to the green-colored left part 421; that means, the drawers 2 are unlocked.

Based on this above, a user can see the color of the plate body 42, red or green, via the window 12 directly from an outside of the cabinet body 1 to check whether the drawers 2 are unlocked or locked even when the user is not familiar with the cabinet. With the cabinet according to the present invention, the user can realize if the drawers 2 can be directly pulled out or if the drawers 2 are necessary to be unlocked, thereby improving the conveniences in using the cabinet.

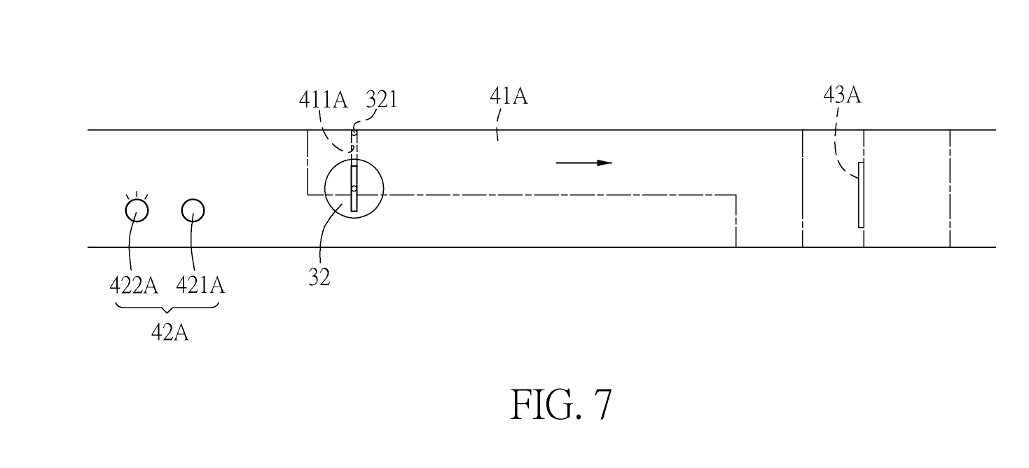

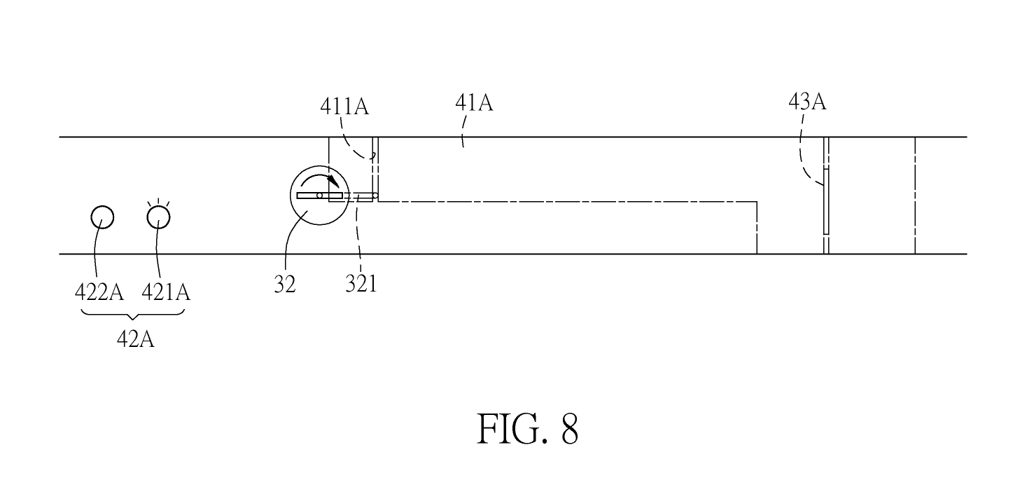

It is realized that, modifications in structures based on the present invention is within the scope of the present invention. Please refer to FIG. 7 and FIG. 8, illustrating a second embodiment of the present invention. The structure of the second embodiment is approximately the same as that of the first embodiment, except that in the second embodiment, the display member is a display lamp 42A assembled to one side of the cabinet body 1, the display lamp 42A includes a green lamp 421A and a red lamp 422A, and a sensor 43A is assembled in the cabinet body 1; particularly, the sensor 43A is assembled to one end of the slide path of the slidable member 41A. In this embodiment, the sensor 43A is assembled at the right side of the slidable member 41A. As shown in FIG. 7, when the lock 31 and the linking-up portion 321 are both unmoved, the slidable member 41A is distant from the sensor 43A, so that the sensor 43A is not contacted by the slidable member 41A and the red lamp 422A is turned on to indicate that the drawers 2 are locked; while as shown in FIG. 8, when the lock 31 is rotated to drive the linking-up portion 321 swinging laterally, the slidable member 41A is slid to come close to the sensor 43A, so that the sensor 43A is contacted by the slidable member 41A, thereby turning off the red lamp 422A and turning on the green lamp 421A to indicate the drawers 2 are unlocked. Based on this, the second embodiment according to the present invention performs the same function as the first embodiment does.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cabinet with display structure showing lock-control state thereof, comprising:
a cabinet body, having a receiving space;
a plurality of drawers, slidably assembled in the receiving space;
a lock-control unit, comprising a driving member, a linking-up member and a lock-control member, wherein the driving member drives the linking-up member to actuate, so that the linking-up member drives the lock-control member to control the drawers in unlocked or locked states; and
a display unit, comprising a slidable member and at least one display member, the slidable member moving laterally along with the actuation of the linking-up member and controlling the at least one display member displaying the drawers in unlocked or locked states.

2. The cabinet with display structure showing lock-control state thereof according to claim 1, wherein the at least one display member moves along with the movement of the slidable member, and the cabinet body further comprises a window, capable of aiming to the display member, assembled within a sliding path of the slidable member, the at least one display member displays the drawers in unlocked or locked states in the window along with the sliding movement of the slidable member.

3. The cabinet with display structure showing lock-control state thereof according to claim 2, wherein the driving member is a lock provided to be unlocked by a key, and the linking-up member is a rod member transversely passing through the cabinet body, the rod member has a linking-up portion corresponding to the slidable member, and the rod member drives the slidable member to slide using the linking-up portion.

4. The cabinet with display structure showing lock-control state thereof according to claim 3, wherein the linking-up portion is reversed U-profiled, and the slidable member defines an accommodating groove for correspondingly receiving the linking-up portion.

5. The cabinet with display structure showing lock-control state thereof according to claim 1, wherein the at least one display member is a display lamp assembled to one side of the cabinet body, and a sensor is assembled in the cabinet body, the sensor is assembled to one end of the slide path of the slidable member, when the slidable member is slid to come close to the sensor, the display member displays the drawers in unlocked or locked states.

6. The cabinet with display structure showing lock-control state thereof according to claim 5, wherein the driving member is a lock provided to be unlocked by a key, and the linking-up member is a rod member transversely passing through the cabinet body, the rod member has a linking-up portion corresponding to the slidable member, and the rod member drives the slidable member to slide using the linking-up portion.

7. The cabinet with display structure showing lock-control state thereof according to claim 6, wherein the linking-up portion is reversed U-profiled, and the slidable member defines an accommodating groove for correspondingly receiving the linking-up portion.

8. The cabinet with display structure showing lock-control state thereof according to claim 1, wherein the lock-control member comprises a guiding rail and a seat, the guiding rail is fixed on an inner wall of the cabinet body and has a slidable groove, the seat has multiple engaging portions and slidably assembled in the slidable groove of the guiding rail, one end of the linking-up member is connected to the seat, thereby driving the seat to slide to control the drawers in unlocked or locked states.
